(19) United States
(12) Patent Application Publication
(10) Pub. No.: US 2010/0302150 A1
(43) Pub. Date: Dec. 2, 2010

(54) PEER LAYERS OVERLAPPING A WHITEBOARD

(76) Inventors: Gerold Keith Shelton, Meridian, ID (US); Michael James Shelton, Boise, ID (US); William Robers Cridland, Boise, ID (US); Steven Harold Taylor, Boise, ID (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/475,173

(22) Filed: May 29, 2009

(51) Int. Cl. G09G 5/08; G06F 3/048; G06F 17/30

(52) U.S. Cl. 345/158; 715/759; 709/204; 707/E17.044

(57) ABSTRACT

A method for displaying edits overlapping a whiteboard comprising creating peer layers overlapping the whiteboard for a peer and peers coupled to the peer and sending or receiving metadata of edits for updating one or more of the peer layers on the peer and the coupled peers in response to any of the peer layers being edited.

### BACKGROUND

When editing a whiteboard, users often physically mark on or erase marks from the whiteboard. Alternatively, if the whiteboard is a virtual whiteboard, the users take turns in taking control of the virtual whiteboard to edit the virtual whiteboard. Once a user has finished editing the virtual whiteboard, a next user then accesses and takes control of the virtual whiteboard and continues to edit the virtual whiteboard.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the disclosed embodiments.

FIG. 1 illustrates a block diagram of a machine/peer displaying a whiteboard with peer layers overlapping the whiteboard according to an embodiment of the invention.

FIG. 2 illustrates a machine/peer coupled to peers and creating peer layers overlapping a whiteboard for the peer and the coupled peers according to an embodiment of the invention.

FIG. 3 illustrates a peer with peer layers overlapping a whiteboard coupled to peers with corresponding peer layers overlapping their corresponding whiteboards according to an embodiment of the invention.

FIG. 4 illustrates one or more corresponding peer layers on coupled peers being updated in response to a machine/peer editing a peer layer according to an embodiment of the invention.

FIG. 5 illustrates one or more peer layers on a peer and one or more corresponding peer layers on coupled peers being updated according to an embodiment of the invention.

FIG. 6 illustrates a machine/peer with an embedded Whiteboard Application and a Whiteboard Application stored on a removable medium being accessed by the machine according to an embodiment of the invention.

FIG. 7 is a flow chart illustrating a method for displaying edits on a whiteboard according to an embodiment of the invention.

FIG. 8 is a flow chart illustrating a method for displaying edits on a whiteboard according to another embodiment of the invention.

### DETAILED DESCRIPTION

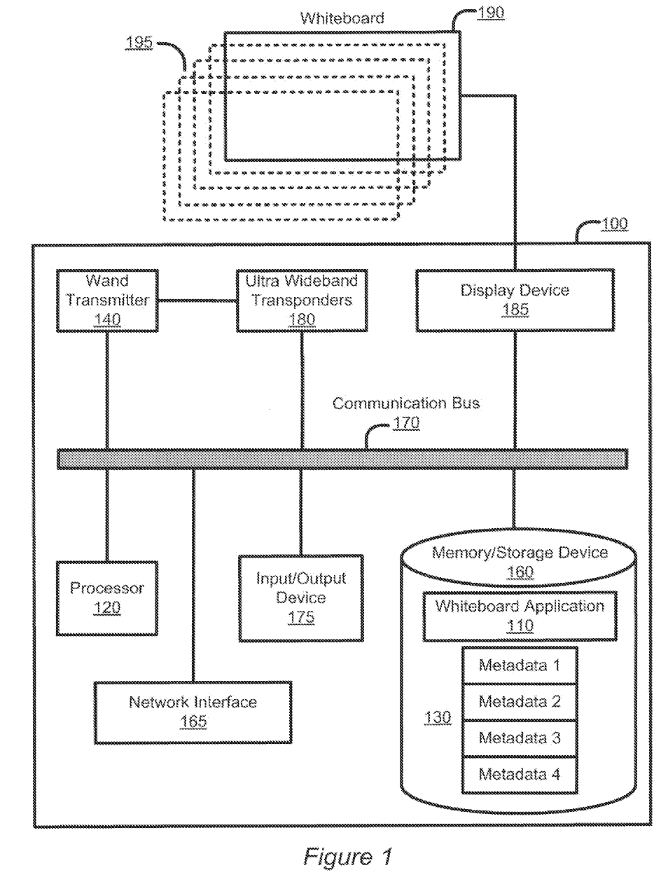

FIG. 1 illustrates a block diagram of a machine/peer 100 displaying a whiteboard 190 with peer layers 195 overlapping the whiteboard 190 according to an embodiment of the invention. In one embodiment, the machine 100 is a peer 100 coupled to peers and the coupled peers are additional machines with configurations and components similar to the machine 100. As illustrated in FIG. 1, the peer 100 includes a processor 120, a wand transmitter 140, one or more ultra wide transponders 180, a display device 185, a network interface 165, an input/output device 175, a memory/storage device 160, and a communication bus 170 for the peer 100 and/or one or more components of the peer 100 to communicate with one another. Additionally, as illustrated in FIG. 1, the storage device 160 stores a whiteboard application 110 and metadata of edits 130. In other embodiments, the peer 100 includes additional components and/or is coupled to additional components in addition to and/or in lieu of those noted above and illustrated in FIG. 1.

As illustrated in FIG. 1, the peer 100 includes a processor 120 coupled to the peer 100. The processor 120 executes instructions for a whiteboard application 110 to create peer layers 195 which overlap a whiteboard 190. For the purposes of this application, a whiteboard 190 is any surface that a display device 185 can display one or more images on. In one embodiment, the whiteboard 190 is a screen included as part of the display device 185, such as a screen of a monitor, that the display device generates an image on. In other embodiments, the whiteboard 190 is any surface not coupled to the display device 185, such as a wall or a pull down screen, that the display device 185 projects an image on. The display device 185 is any device that can generate peer layers 195 overlapping the whiteboard 195. In one embodiment, the display device 185 is a monitor. In other embodiments, the display device 185 is a projector.

Additionally, in one embodiment, the image is included on or embedded as part of the whiteboard 190. In other embodiments, the image is separate and is displayed on the whiteboard by the display device 185. Further, each of the coupled peers includes corresponding display devices that display corresponding whiteboard with corresponding peer layers overlapping the corresponding whiteboards. In one embodiment, the whiteboard 190 of the peer 100 and the corresponding whiteboards for each coupled peer all include or display the same image on the whiteboard 190 and the corresponding whiteboards.

As illustrated in FIG. 1, the peer layers 195 are virtual layers which overlap one another and the whiteboard 190. Additionally, the corresponding peer layers of the coupled peers are also virtual layers which overlap one another and the corresponding whiteboards. In one embodiment, as illustrated in FIG. 1, the peer layers 195 are bitmaps, screens, and/or maps which are used as masks to overlap the whiteboard 190. The peer layers 195 can be edited by the peer 100 and by any of the coupled peers. For the purposes of this application, the act of editing peer layers 195 includes, but is not limited to, creating marks or erasing marks on one or more peer layers 195.

Additionally, any of the coupled peers can edit the peer layers by editing their corresponding peer layers and sending metadata of edits 130 made to one or more of the corresponding layers to the peer 100. Upon receipt of the metadata of edits 130, the whiteboard application 110 utilizes the metadata of edits 130 to update one or more of the specified peer layers 195. As a result, when the peer 100 edits any of the peer layers overlapping the whiteboards, the whiteboard 190 and any images on the whiteboard 190 will as appear as though they are being directly edited. Additionally, when any of the coupled peers edit any of their corresponding peer layers overlapping their corresponding whiteboards, the whiteboard 190 and any images on the whiteboard 190 will also appear as though they are being directly edited.

One or more marks are any visual symbols, characters, and/or drawings that are visible on the peer layers 195 and the corresponding peer layers. Further, in one embodiment, the peer layers 195 are transparent and are configured to display any edits made to any of the peer layers 195 by the peer 100 or any of the coupled peers.

The peer 100 creates ‘N’ peer layers for ‘N’ coupled peers. In one embodiment, 3 peers are coupled to the peer 100. As a result, there are N=4 number of peers coupled, the peer and the 3 coupled peers, to one another and the whiteboard application 110 creates 4 peer layers that overlaps the whiteboard 190 on the peer 100. Additionally, each of the peers coupled to the peer 100 also create 4 corresponding peer layers which overlap their corresponding whiteboards.

Each of the peer layers 195, in the present embodiment 4 peer layers, overlapping the whiteboard 190 are designated for each peer. In one embodiment, a first peer layer overlapping the whiteboard 190 is designated for the peer 100, a second peer layer overlapping the first peer layer and the whiteboard 190 is designated for a first peer coupled to the peer 100, a third peer layer overlapping the first and second peers layers as well as the whiteboard 190 is designated for a second peer coupled to the peer 100, and a top peer layer overlapping all of the peer layers and the whiteboard 190 is designated for a third peer coupled to the peer 100.

Likewise, each of the coupled peer's corresponding peer layers will be designated for each peer. Additionally, each of the couple's peer's corresponding peer layers will directly correspond to one of the peer layers 195 of Peer 100. As a result, the peer 100 and the coupled peers will each have a peer layer or corresponding peer layer that they can each directly edit. Additionally, the peer 100 and the coupled peers can also directly edit one another's peer layers.

In other embodiments, the peer layers 195 can be jointly edited by the peer 100 or by any of the coupled peers. A wand transmitter 140 in conjunction with one or more ultra wideband transponders 180 are used by a user on the peer 100 in controlling and editing the peer layers 195 overlapping the whiteboard 190. In one embodiment, the coupled peers additionally utilize a wand transmitter and one or more ultra wideband transponders to edit corresponding peer layers overlapping their corresponding whiteboards.

A wand transmitter 140 is a hand held device utilized to edit the peer layers 195 overlapping the whiteboard 190. The wand transmitter 140 includes button controls. The button controls on the wand transmitter 140 represent any user activated control for initiating an action when the user is editing any of the peer layers 195. In one embodiment, one of the button controls on the wand transmitter 140 is a marking button that the user presses when creating marks on any of the peer layers 195. In another embodiment, the wand transmitter 140 includes an erase button that the user presses when erasing any existing marks on any of the peer layers 195. In other embodiments, the wand transmitter further includes one or more layer buttons that can identify or switch between the peer layers 195. In further embodiments, the wand transmitter 140 includes additional buttons which are used for additional purposes in addition to and/or in lieu of those noted above.

In editing any of the peer layers 195, a user on the peer presses one or more of the buttons on the wand transmitter 140 and moves the wand transmitter 140 in one or more directions. In one embodiment, the user initially chooses one of the peer layers 195 to edit. After choosing one of the peer layers 195, the user then presses the marking button and moves the wand in a horizontal motion to edit one or more of the peer layers 195. In detecting and identifying edits made by the user, the wand transmitter 140 includes transmitters positioned at various locations on the wand transmitter 140, such as on a top or bottom portion of the wand transmitter 140, so as to identify a position and/or an orientation of the wand transmitter 140 in reference to the whiteboard 190. The transmitters on the wand transmitter 140 send information that one or more ultra wideband transponders 180 can detect and interpret.

One or more ultra wideband transponders 180 are communication devices connected wirelessly or through a wired connection to the wand transmitter 140 and the peer 100. In one embodiment, one or more ultra wideband transponders 180 can be placed at different locations around an environment of the peer 100, the wand transmitter 140, and/or the whiteboard 190. Additionally, one or more ultra wideband transponders 180 are configured to use positioning techniques, such as trilateration, to identify positions and track movement of the wand transmitter 140 in reference to the whiteboard 190.

In one embodiment, the wand transmitter 140 is coupled to one or more ultra wideband transponders 180 and the whiteboard application 110 on the peer 100 with a wired connection. In other embodiments, the wand transmitter 140 is coupled to the whiteboard application 110 and one or more ultra wideband transponders 180 wirelessly. The wand transmitter 140 communicates to whiteboard application 110 and one or more ultra wideband transponders 180 using cables or wireless remote connections via a telecommunication link, an infrared link, a radio frequency link, or any other connector or system of connectors that provides communication between the wand transmitter 140, one or more ultra wideband transponders 180, and the peer 100.

The wand transmitter 140 is configured to transmit information of one or more buttons that have been pressed on the wand transmitter 140 to one or more ultra wideband transponders 180 and the whiteboard application 110. When one or more ultra wideband transponders 180 detects a user editing any of the peer layers 195 by inputting any of the buttons, changing a position, and/or moving the wand transmitter 140, information of the edits are sent to the whiteboard application 110. Additionally, the transmitters on the wand transmitter 140 also send information of any inputs and/or movements made to the wand transmitter's 140 in reference to the whiteboard 190 to the whiteboard application 110.

Upon receipt of this information, the whiteboard application 110 can interpret this information to determine a type of editing action that the user wishes to perform. Once the type of edit has been interpreted, the whiteboard application 110 can convert the type of editing action identified to metadata of the edits 130. Additionally, the whiteboard application 110 sends instructions for the display device 185 to display the edits made to any of the peer layers 195 in response to the metadata of edits 130. Further, the whiteboard application 110 can also send the metadata of edits 130 to any of the coupled peers. In one embodiment, the whiteboard application 110 additionally sends instructions for the coupled peers to update their corresponding peer layers based on the metadata of edits 130 sent. The instruction to update is included in the metadata of edits 130 or it is sent as a separate command.

The metadata of edits 130 indicate what form of edits (creation of marks or erasing of marks) to make to one or more of the peer layers 195. Additionally, the metadata of edits 130 specify which of the peer layers 195 to edit or have been edited. Further, the metadata of edits 130 indicate which of the peers made the edits and what time the edits were made. The metadata of edits 130 also indicate user settings for the peer 100 and image placement data for the whiteboard 190. In one embodiment, metadata of edits 130 is created by the peer 100 or any of the coupled peers when any of the peers have edited any of the peer layers 195. In other embodiments, the metadata of edits 130 are created and continued to be updated whenever the peer 100 or any of the coupled peers have edited any of the peer layers 195.

As a result, the metadata of edits 130 provide a footprint for the peer 100 and/or the coupled peers as to the form of edit, which peer layers to edit, who made the edits, and when the edits were made. In other embodiments, the metadata of edits 130 indicate or reference additional information in addition to and/or in lieu of those noted above. For the purposes of this application, the metadata of edits 130 will refer to one or more sets of metadata of edits corresponding to the peer 100 and/or any of the coupled peers. The corresponding set of metadata of edits 130 include all of the metadata of edits 130 that the corresponding peer has made.

As illustrated in FIG. 1, in one embodiment, the metadata of edits 130 are stored in the memory/storage device 160 on the peer 100. Additionally, in another embodiment, the coupled peers also include memory/storage devices that are configured to store metadata of edits 130 corresponding to one or more of the peers. In other embodiments, a server is coupled and accessible to the peer 100 and the coupled peers to store metadata of edits 130 corresponding to the peer 100 and the coupled peers. The metadata of edits 130 are used by the whiteboard application 110 in creating and updating the peer layers 195 overlapping the whiteboard 190.

A whiteboard application 110 is an application that creates peer layers 195 that overlap the whiteboard 190 for the peer 100 and the coupled peers for display on the display device 185. The whiteboard application 100 creates the peer layers 195 for the peer 100. Additionally, the whiteboard application 110 sends and/or receives metadata of edits 130 for updating one or more of the peer layers 195 on the peer 100 and the coupled peers in response to any of the peer layers being edited.

In one embodiment, the whiteboard application 110 is firmware that is embedded onto the peer 100. In other embodiments, the whiteboard application 110 is a software application stored on the peer 100 within ROM or on a storage device 160 accessible by the machine 100 or the whiteboard application 110 is stored on a computer readable medium readable and accessible by the peer 100 from a different location. In a further embodiment, the whiteboard application 110 is stored and/or accessed through a server coupled through a local area network or a wide area network. The whiteboard application 110 communicates with devices and/or components coupled to the peer 100 physically or wirelessly through a communication bus 170 included in or attached to the peer 100. In one embodiment the communication bus 170 is a memory bus. In other embodiments, the communication bus 170 is a data bus.

As noted above, the whiteboard application 110 creates and sends metadata of edits 130 when a user on the peer 100 edits any of the peer layers 195 overlapping the whiteboard 190 with the wand transmitter 140. Additionally, as noted above, the whiteboard application 110 sends instructions with the metadata of edits 130 for the coupled peers to immediately update the specified peer layers from their corresponding peer layers. When the coupled peers receive the metadata of edits 130 and the instruction to update, the coupled peers will use the metadata of edits 130 to immediately identify which of the corresponding peer layers to update. Once one or more of the corresponding peer layers have been identified, the coupled peers will update one or more of the corresponding peer layers accordingly.

Additionally, the whiteboard application 110 receives metadata of edits 130 when any of the coupled peers edit any of their corresponding peer layers overlapping their corresponding whiteboards. When the whiteboard application 110 receives the metadata of edits 130, the whiteboard application 110 immediately use the metadata of edits 130 to identify one or more of the corresponding peer layers which have been edited and proceeds to update one or more of the specified peer layers 195 overlapping the whiteboard 190.

Further, upon request by the peer 100 or any of the coupled peers, the whiteboard application 110 can merge one or more of the peer layers 195 down to a single layer. In other embodiments, upon request by the peer 100 or any of the coupled peers, the whiteboard application 110 creates new or replacement peer layers 195 for the peer 100 or any of the coupled peers.

As noted above, in one embodiment, the peer 100 and the coupled peers each include metadata of edits 130 corresponding to the peer 100 and each of the coupled peers. In one embodiment, if the peer 100 was originally coupled to the peers, but became decoupled, the whiteboard application 110 can recouple to one or more of the peers and recover metadata of edits 130 corresponding to the peer 100 from any of the coupled peers. Additionally, as noted above, in other embodiments, the peer 100 stores metadata of edits 130 corresponding to each peer. When any of the peers recouple to the peer 100 after being decoupled, the peer 100 can also send the metadata of edits 130 corresponding to the recoupling peer to the recoupling peer. Any of the actions or functions performed by the whiteboard application 110 can be performed in any order and can be performed concurrently while the whiteboard application 110 performs similar or different actions.

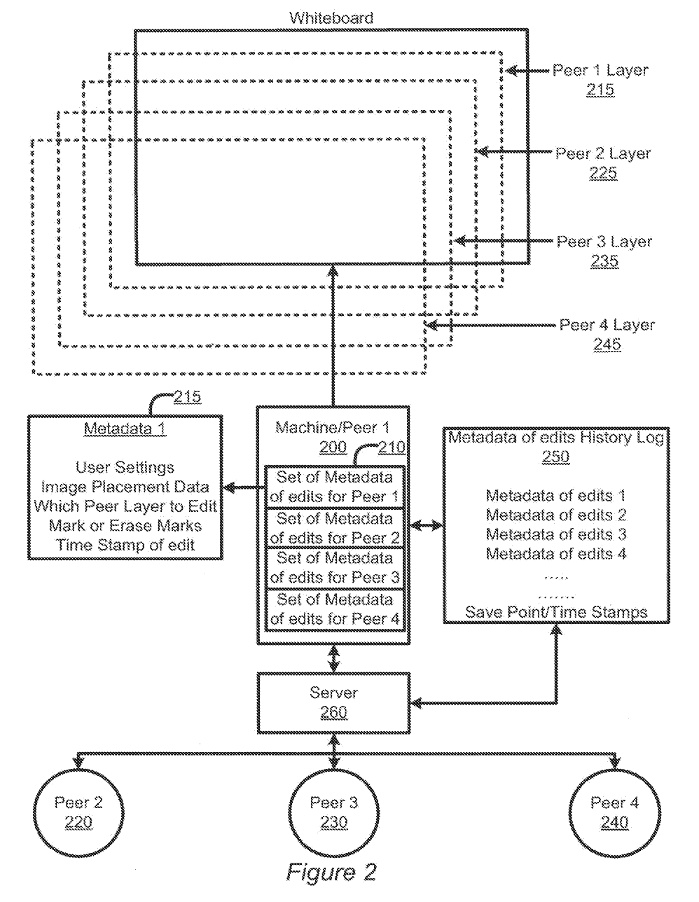

FIG. 2 illustrates a machine/peer 200 coupled to peers and creating peer layers (Peer 1 layer 215, Peer 2 layer 225, Peer 3 layer 235, and Peer 4 layer 245) overlapping a whiteboard for the peer 200 and the coupled peers (Peer 2 220, Peer 3 230, and Peer 4 240) according to an embodiment of the invention. As noted above and illustrated in FIG. 2, in one embodiment, the machine 200 is a peer (Peer 1 200). Additionally, FIG. 2 illustrates Peer 1 200 storing metadata of edits 210 corresponding to each peer and creating a metadata of edits history log 250. As noted above, Peer 1 200 includes a whiteboard application that creates peer layers for Peer 1 200 and each coupled peer.

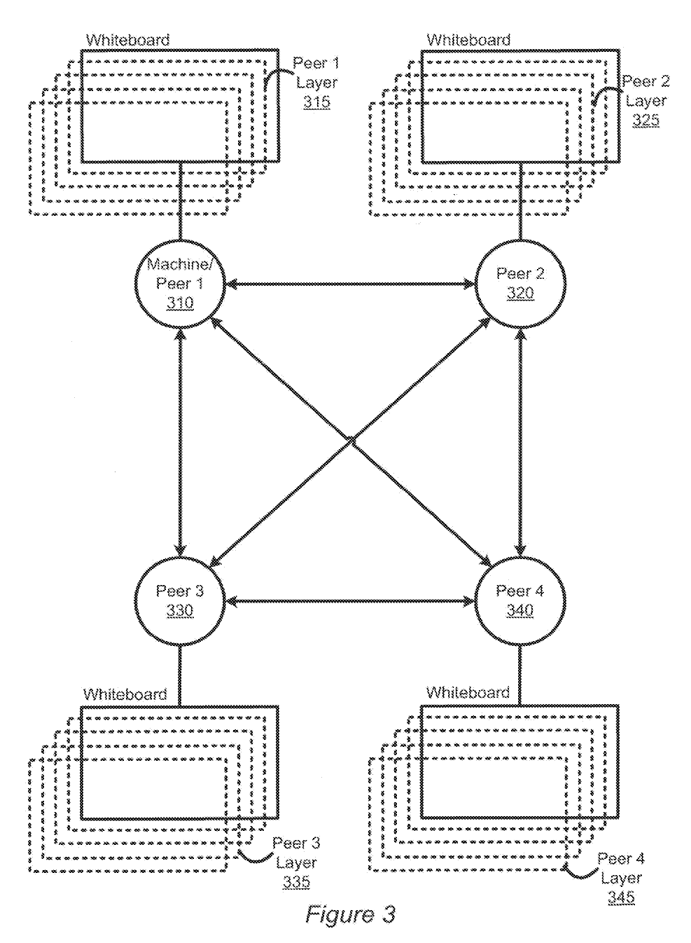

As noted above and illustrated in FIG. 2, Peer 1 200 and each coupled peer are designated a peer-layer. As illustrated in FIG. 3, peer 200 is coupled to 3 peers. As a result, the whiteboard application creates 4 peer layers which overlap the whiteboard. Peer 1 Layer 215 is created for and is designated to Peer 1 200, Peer 2 Layer 225 is created for and is designated to Peer 2 220, Peer 3 Layer 235 is created for and is designated to Peer 3 230, and Peer 4 Layer 245 is created for and is designated to Peer 4 240.

As noted above, in one embodiment, each of the coupled peers also include corresponding whiteboards with corresponding peer layers. Similar to the whiteboard application on Peer 1 200, in one embodiment, each of the coupled peers additionally include corresponding whiteboards applications that create corresponding peer layers for Peer 1 200, Peer 2 220, Peer 3 230, and Peer 4 240. Additionally, as noted above, each of the corresponding peer layers on the coupled peers will directly correspond to one of the peer layers on the peer 200. Further, as noted above, metadata of edits 210 are received from the coupled peers when any of the coupled peers make edits to any of their corresponding peer layers. Additionally, metadata of edits 210 are sent by the Peer 200 to all of the coupled peers when Peer 200 makes edits to any of the peer layers.

As noted above and illustrated in FIG. 2, Peer 200 stores metadata of edits 210 sent to the coupled peers and metadata of edits received 210 from the coupled peers. Additionally, as noted above, the metadata of edits 210 include sets of metadata of edits corresponding to each peer. Further, as noted above and illustrated in FIG. 2, the metadata of edits 210 specify user settings corresponding to the peers, image placement data of where on the whiteboard an image is positioned, which peer layer is to be edited, what form of edit (marking or erasing of marks), as well as time stamps for the edits made. As noted above, the metadata of edits 210 are used by the Peer 200 to update peer layer(s) and/or the coupled peers to update corresponding peer layers to display any edits made by the peer 200 or the coupled peers.

Further, as noted above, in one embodiment, Peer 200 is coupled to the peers through a server 260. In other embodiments, Peer 200 is directly coupled to the peers with a peer to peer type connection. The server 260 acts as an intermediary between the peer 300 and the peers coupled to the peer 200. Additionally, in one embodiment, the server 260 stores metadata of edits. 215 corresponding to the peer 300 and metadata of edits 215 corresponding to the coupled peers.

Further, as noted above, in one embodiment, a metadata of edits History Log 250 can be created and stored by the peer 200 and the coupled peers. In other embodiments, the metadata of edits History Log 250 can be created and stored by the server 260. As illustrated in FIG. 2, the metadata of edits history log 250 stores corresponding metadata of edits 210 sent to and received from the peer 200 and the peers coupled to the peer 200. Additionally, the metadata of edits History Log 250 creates save points or time stamps for each of the metadata of edits 210. In one embodiment, the save points or times stamps are made upon request by the peer 200 or any of the coupled peers. In other embodiments, the save points or time stamps are automatically made periodically. As a result, the metadata of edits History Log 250 creates indexes of each edit made by any of the peers (the peer 200 and the peers coupled to the peer 200), as well as indicates when the edits were made by any of the peers. The metadata of edits History Log 250 can be used by the peer 200 or any of the peers coupled to the peer 200 to undo or redo any edits made to any of the peer layers made by any of the peers.

FIG. 3 illustrates a peer 310 with peer layers (Peer 1 Layer 315, Peer 2 Layer 325, Peer 3 Layer 335, and Peer 4 Layer 345) overlapping a whiteboard coupled to peers (Peer 2 320, Peer 3 330, and Peer 4 340) with corresponding peer layers overlapping their corresponding whiteboards according to an embodiment of the invention. As noted above, a display device on the Peer 310 displays a whiteboard with overlapping peer layers. Further, as noted above and illustrated in FIG. 3, the coupled Peers (320, 330, and 340) also display corresponding peer layers which overlapping their corresponding whiteboards.

In one embodiment, as illustrated in FIG. 3, the Peer 1 310 is coupled to 3 Peers (Peer 2 320, Peer 3 330, and Peer 4 340). As noted above, the Peer 1 310 includes a whiteboard application configured to detect when Peers are coupled to Peer 1 310 and create a peer layer for each coupled peer. In the present embodiment, as illustrated in FIG. 3, the whiteboard application on Peer 1 310 creates 4 peer layers overlapping the whiteboard of peer 1 310, a designated peer layer 1 315 for Peer 1 310, a designated peer layer 2 325 for Peer 2 320, a designated peer layer 3 335 for Peer 3 330, and a designated peer layer 4 345 for Peer 4 340. As illustrated in FIG. 3, the peer layers overlap one another and the whiteboard.

Similar to Peer 1 310, in one embodiment, as illustrated in FIG. 3, the coupled Peers (Peer 2 320, Peer 3 330, and Peer 4 340) also create 4 corresponding peer layers overlapping their corresponding whiteboards. The coupled peers create a corresponding peer layer 1 315 for Peer 1 310, a corresponding peer layer 2 325 for Peer 2 320, a corresponding peer layer 3 335 for Peer 3 330, and a corresponding peer layer 4 345 for Peer 4 340. As a result, each of the peers (Peer 1 310, Peer 2 320, Peer, 3 330, and Peer 4 340) each have a corresponding peer layer designated to each of the peers.

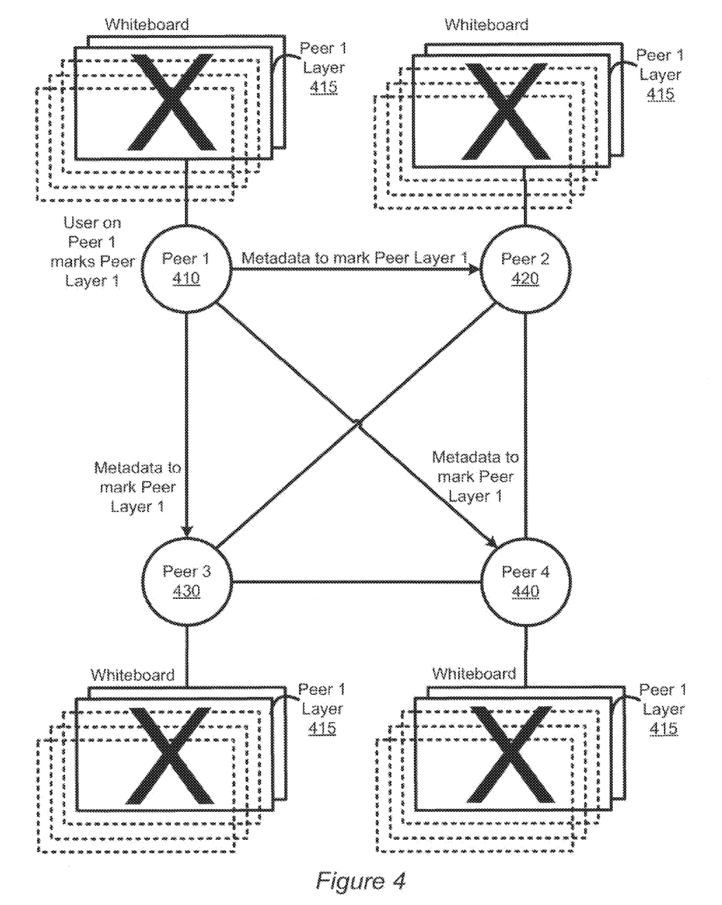

FIG. 4 illustrates one or more corresponding peer layers on coupled peers (Peer 2 420, Peer 3 430, and Peer 4 440) being updated in response to a machine/peer 410 editing a peer layer (Peer 1 Layer 415) according to an embodiment of the invention. As noted above, in one embodiment, Peer 1 410 includes a whiteboard application that creates a whiteboard with peer layers overlapping the whiteboard. Additionally, as noted above and illustrated in Figure 4, the whiteboard application detects when any of the peer layers have been edited by a user on Peer 1 410. As noted above, a user can edit any of the peer layers utilizing a wand transmitter and marking or erasing marks on any of the peer layers.

As illustrated in FIG. 4, in one embodiment, a user on Peer 1 410 edits peer 1 layer 415 by marking peer 1 layer 415 with an ‘X’ using the wand transmitter. Once the whiteboard application on Peer 1 410 has detected the edit, the whiteboard application will immediately create metadata of the edits and send the metadata of edits to the coupled peers (Peer 2 420, Peer 3 430, and Peer 4 440). Additionally, as noted above, the whiteboard application also concurrently sends an instruction for the coupled peers to immediately update their corresponding peer layer 1 415 for Peer 1 410 with the metadata of edits. As illustrated in FIG. 4, when the coupled peers receive the metadata of edits, indicating that Peer layer 1 415 was marked with an “X,” the coupled peers will immediately update their corresponding Peer layer 1 415 to include the “X.” As a result, all of the peers, reflect that peer 1 layer 415 was edited with an “X” mark.

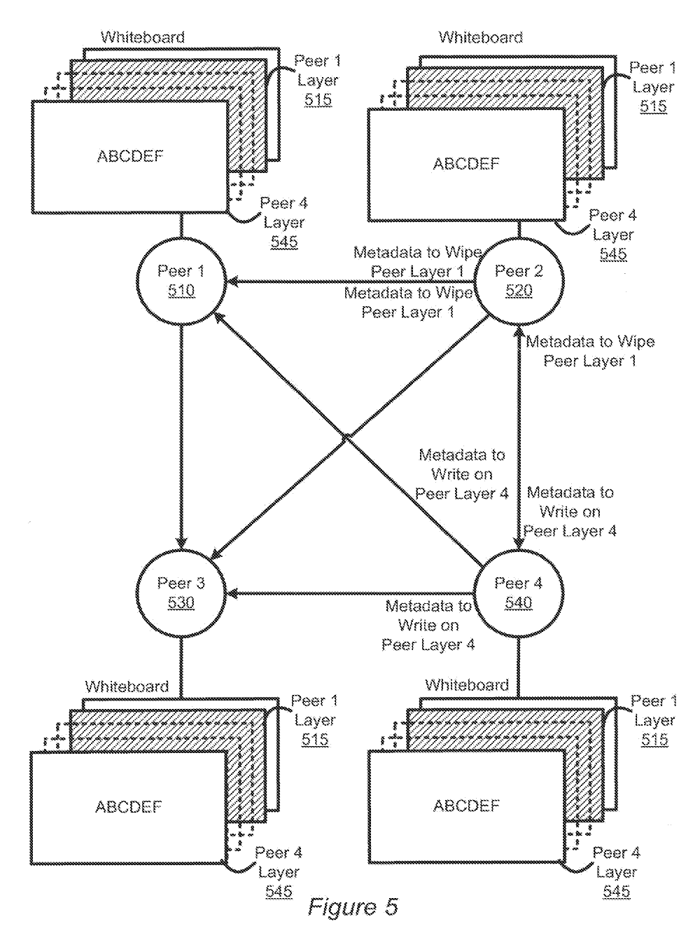

FIG. 5 illustrates one or more peer layers (Peer 1 layer 515 and Peer 4 layer 545) on a peer and one or more corresponding peer layers on coupled peers (Peer 2 520, Peer 3 530, and Peer 4 540) being updated according to an embodiment of the invention. As shown in FIG. 5, in one embodiment, Peer 1 510 edits peer 1 layer 515 by performing a wiping or erasing action. In wiping Peer 1 layer 515, a user on Peer 1 510 uses a wand transmitter to perform a wiping or erasing action.

A whiteboard application on Peer 1 510 will detect this edit and immediately create metadata of edits indicating the wiping action to Peer 1 layer 515 and send the metadata of edits to coupled peers (Peer 2 520, Peer 3 530, and Peer 4 540). Additionally, as noted above, the whiteboard application will also send an instruction for the coupled peers to immediately update their corresponding Peer 1 layer 515 with the metadata of edits received. As illustrated in FIG. 5, upon receipt of the metadata of edits indicating to wipe corresponding Peer 1 layer 515, the coupled peers will also wipe their corresponding peer 1 layer 515.

Additionally, as illustrated in FIG. 5, in one embodiment, Peer 4 540 is also concurrently editing Peer 4's 540 corresponding Peer 4 layer 545 by writing letters onto Peer 4 layer 545, “ABCDEF.” Further, as noted above, when any of the coupled peers, in the present embodiment Peer 4 540, edit any of their corresponding peer layers, the peer making the edit will create and send metadata of the edits to Peer 1 510 and other coupled peers (Peer 2 520 and Peer 3 530). When Peer 1 510 receives the metadata of edits, Peer 1 510 will immediately update Peer 1's Peer 4 layer 545. Additionally, once the other coupled peers receive from the metadata of edits, the other coupled peers will immediately update their corresponding Peer 4 layer 545. As a result, as illustrated in FIG. 5, all of the peers coupled together all view the edits made to any of the peer layers made by one another.

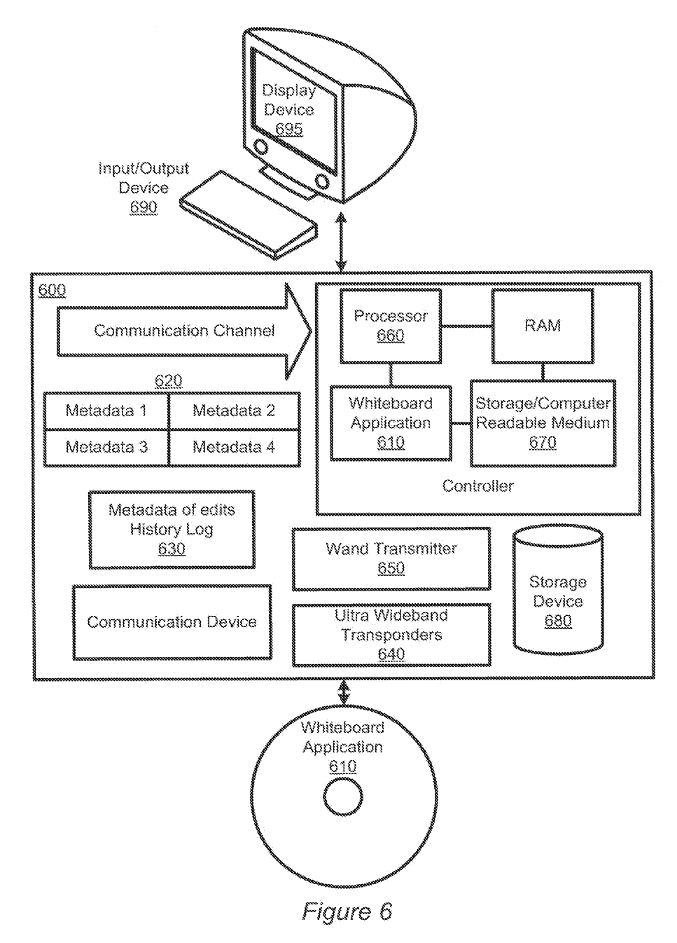

FIG. 6 illustrates a machine/peer 600 with an embedded Whiteboard Application 610 and a Whiteboard Application 610 stored on a removable medium being accessed by the peer 600 according to an embodiment of the invention. For the purposes of this description, a removable medium is any tangible apparatus that contains, stores, communicates, or transports the application for use by or in connection with the peer 600. As noted above, in one embodiment, the Whiteboard Application 610 is firmware that is embedded into one or more components of the peer 600 as ROM. In other embodiments, the Whiteboard Application 610 is a software application which is stored and accessed from a hard drive, a compact disc, a flash disk, a network drive or any other form of computer readable medium that is coupled to the peer 600.

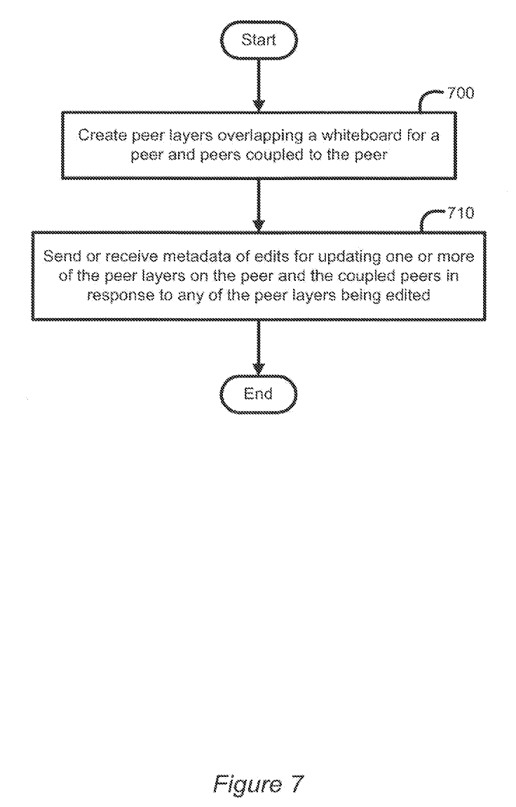

FIG. 7 is a flow chart illustrating a method for displaying edits on a whiteboard according to an embodiment of the invention. The method of FIG. 7 uses a machine/peer coupled to peers, a wand transmitter, one or more ultra wideband transponders, a display device, a whiteboard application with overlapping peer layers, and metadata of edits. As noted above, in one embodiment, the machine is a peer that is coupled to peers. In other embodiments, the method of FIG. 7 uses additional components and/or devices in addition to and/or in lieu of those noted above and illustrated in FIGS. 1, 2, 3, 4, 5, and 6.

As noted above, a whiteboard application on the peer initially creates peer layers overlapping a whiteboard for a peer and peers coupled to the peer 700. Additionally, as noted above, the number of peer layers created by the whiteboard application will be based on the number of peers coupled to the peer. The peer and the peers coupled to the peer Will each have a designated peer layer overlapping the whiteboard. Additionally, each of the coupled peers will additionally have corresponding whiteboards with overlapping corresponding peer layers overlapping for the peer and each of the coupled peers.

After the peer layers have been created for the peer and the coupled peers, the whiteboard application will scan for one or more users on the peer editing any of the peer layers. As noted above, the user uses a wand transmitter to make edits. The wand transmitter sends information to the whiteboards application and one or more ultra wideband transponders, which also send position and movement information detected from the wand transmitter. When the whiteboard application detects and receives the information from the wand transmitter and one or more ultra wideband transponders, the whiteboard application will identify the editing action and create metadata of edits of the identified edit. The whiteboard application will then instruct a display device to update one or more of the peer layers accordingly and send metadata of edits made to one or more of the peer layers to the coupled peers.

Additionally, the whiteboard application will receive metadata of edits when any of the coupled peers have made edited any of their corresponding peer layers. Using the metadata of edits received, the whiteboard application will immediately update one or more of the specified peer layers. As a result, the whiteboard application will send or receive metadata of edits for updating one or more of the peer layers on the peer and the coupled peers in response to any of the peer layers being edited 710. In other embodiments, the method of FIG. 7 includes additional steps in addition to and/or in lieu of those depicted in FIG. 7.

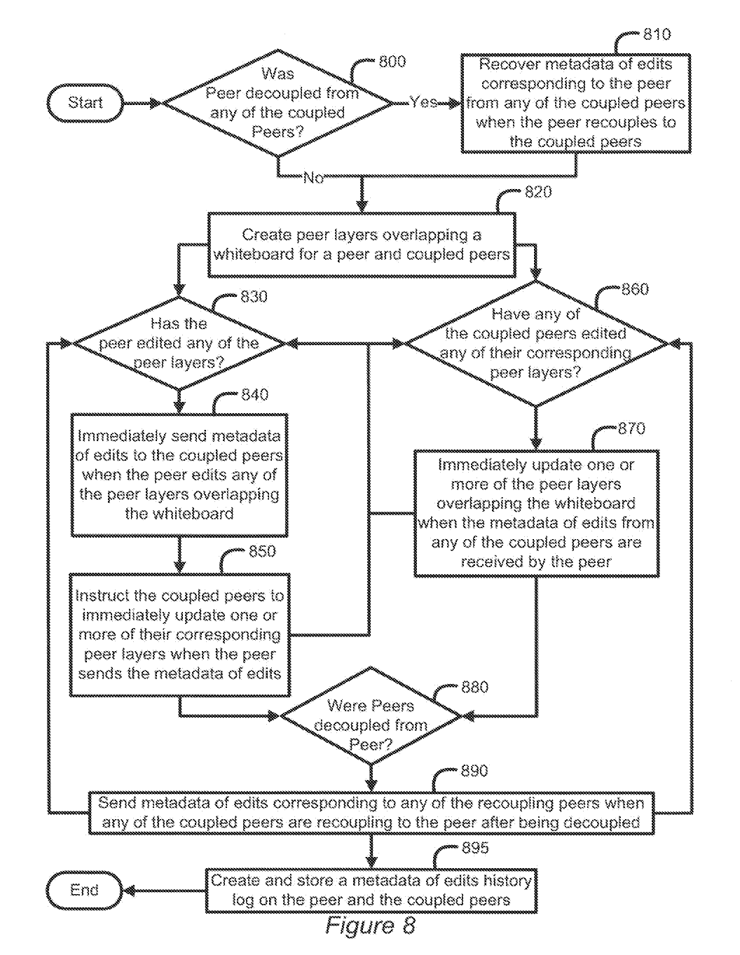

FIG. 8 is a flow chart illustrating a method for displaying edits on a whiteboard according to another embodiment of the invention. The method of FIG. 8 uses a machine/peer coupled to peers, a wand transmitter, one or more ultra wideband transponders, a display device, a whiteboard application with overlapping peer layers, and metadata of edits. In other embodiments, the method of FIG. 8 uses additional components and/or devices in addition to and/or in lieu of those noted above and illustrated in FIGS. 1, 2, 3, 4, 5, and 6.

As noted above and illustrated in FIG. 8, the whiteboard application initially determines whether the peer is recoupling to peers after being decoupled 800. If the peer was previously decoupled and is currently recoupling, the whiteboard application on the peer sends a request to one or more of the coupled peers to recover metadata of edits corresponding to the peer 810. As noted above, the metadata of edits includes sets of metadata of edits corresponding to the peer and indicates any of the edits (marking and erasing) done by the peer to any of the peer layers overlapping the whiteboard. Further, any of the coupled peers can send metadata of edits corresponding to the peer, so that the peer can utilize the metadata of edits corresponding to the peer to re-edit overlapping peer layers and return to a state before it was decoupled.

As a result, once the peer has received the metadata of edits corresponding to the peer, the whiteboard application on the peer will utilize the metadata of edits to create peer layers overlapping a whiteboard for a peer and the coupled peers 820. If the peer was not previously decoupled, the whiteboard application on the peer skips step 810 and proceeds to create blank peer layers overlapping the whiteboard and the coupled peers 820. As noted above, the whiteboard application creates an overlapping peer layer for each of the peers. Additionally, as illustrated in FIG. 8, the whiteboard application on the peer concurrently scans the peer and the coupled peers to determine whether the peer has edited any of the peer layers 830 and whether any of the coupled peers have edited any of their corresponding peer layers 860.

As noted above, if the peer has edited any of the peer layers overlapping the whiteboard for the peer, the whiteboard application will immediately send metadata of edits to the peers coupled to the peer 840 so that the coupled peers can update one or more of their corresponding peer layers overlapping their corresponding whiteboard. Additionally, the whiteboard application will instruct the coupled peers to immediately update one or more of their corresponding peer layers when the peer sends the metadata of edits 850. As noted above, in one embodiment, the instruction to update immediately is included in the metadata of edits. In other embodiments, the instruction to update immediately is included in a separate instruction or command issued by the whiteboard application on the peer.

After the coupled peers have been sent the instruction to update immediately, in one embodiment, the whiteboard application continues to concurrently determine whether the peer has edited any of the peer layers 830 and whether any of the coupled peers have edited any of their corresponding peer layers 860. Additionally as illustrated in FIG. 8, the whiteboard application can also determines whether any of the peers have been decoupled from the peer 880. In other embodiments, the whiteboard application additionally concurrently determines whether any of the coupled peers have been decoupled from the peer 880 while also determining whether the peer or any of the coupled peers have edited any of their corresponding peer layers 860.

If any of the coupled peers have edited any of their corresponding peer layers, the peer making edits will send metadata of edits to the peer and other coupled peers. The whiteboard application, upon receipt of the metadata of edits, will immediately update one or more peer layers overlapping the whiteboard with the metadata of edits 870. As noted above, the metadata of edits will indicate which of the peer layers to edit. As illustrated in FIG. 8, the whiteboard application continues to concurrently determine whether the peer has edited any of the peer layers 830 and whether any of the coupled peers have edited any of their corresponding peer layers 860 after updating one or more peer layers with the metadata of edits. Further, as illustrated in FIG. 8, the whiteboard application can also proceed to determine whether any of the coupled peers have been decoupled from the peer 880.

If any of the peers are recoupling to the peer after being decoupled, the peer or any of the other peers can send metadata of edits corresponding to any of the recoupling peers 890. The whiteboard application on the peer can then repeat steps 830 and 860 or the whiteboard application proceeds to create and store a metadata of edits history log on the peer and the coupled peers 895. As noted above, in one embodiment, the peer and the coupled peers periodically or upon request update a metadata of edits history log that all of the peers store. Utilizing the metadata of edits history log, the peer or any of the coupled peers can undo any edits made by any of the peers and return to a previous edited state.

The method is then complete, or the whiteboard application can continue to repeat the process or any of the steps disclosed in FIG. 8. In other embodiments, the method of FIG. 8 includes additional steps in addition to and/or in lieu of those depicted in FIG. 8.

By immediately sending or receiving metadata of edits when editing peer layers overlapping a whiteboard on a peer or when editing corresponding peer layers overlapping corresponding whiteboards on coupled peers, the peer and the coupled peers can freely edit and view edits made to the peer layers or the corresponding peer layers. As a result, time is saved for the peer and the coupled peers since the peers can accurately view, in real time, edits made by each peer at all times. Additionally, security, flexibility, and user friendliness is increased by having the peers maintain metadata of edits history logs and allowing the peers to edit any of the peer layers or any of the corresponding peer layers.

What is claimed is:

1. A method for displaying edits overlapping a whiteboard comprising:
creating peer layers overlapping the whiteboard for a peer and peers coupled to the peer; and
sending or receiving metadata of edits for updating one or more of the peer layers on the peer and the coupled peers in response to any of the peer layers being edited.

2. The method for displaying edits overlapping a whiteboard of claim 1 wherein the metadata of edits is sent from the peer to the coupled peers when the peer edits any of the peer layers overlapping the whiteboard.

3. The method for displaying edits overlapping a whiteboard of claim 1 wherein the peer receives the metadata of edits from the coupled peers when any of the coupled peers edit any of their corresponding peer layers.

4. The method for displaying edits overlapping a whiteboard of claim 2 further comprising instructing the coupled peers to immediately update one or more of their corresponding peer layers when the peer sends the metadata of edits.

5. The method for displaying edits overlapping a whiteboard of claim 1 wherein the metadata of edits indicate at least one from the group consisting of user settings, image placement data, which of the peer layers to edit, and whether to mark or erase marks on the peer layers to edit.

6. The method for displaying edits overlapping a whiteboard of claim 5 further comprising storing the metadata of edits sent by the peer and received from the coupled peers.

7. The method for displaying edits overlapping a whiteboard of claim 6 further comprising creating and storing a metadata of edits history log on the peer and the coupled peers.

8. A machine comprising:
a processor;
a wand transmitter coupled to one or more ultra wideband transponders and configured to edit one or more peer layers overlapping a whiteboard;
a whiteboard application executed by the processor and configured to create peer layers overlapping the whiteboard and send or receive metadata of edits when updating one or more of the peer layers overlapping the whiteboard.

9. The machine of claim 8 wherein the machine is coupled to one or more peers and the coupled peers include corresponding whiteboards and corresponding peer layers overlapping their corresponding whiteboards.

10. The machine of claim 9 wherein one or more peer layers on the machine and one or more corresponding peer layers on the coupled peers are immediately updated using the metadata of edits when the machine or any of the coupled peers send or receive the metadata of edits.

11. The machine of claim 8 further comprising a display device configured to display edits made to any of the peer layers overlapping the whiteboard.

12. The machine of claim 11 wherein the peer layers are virtual layers displayed with the display device and edited with the wand transmitter.

13. The machine of claim 8 further comprising a metadata of edits history log that stores a history of edits made to one or more of the peer layers overlapping the whiteboard.

14. The machine of claim 13 wherein the metadata history log is used by the machine or the coupled peers to undo or redo edits made to any of the peer layers overlapping the whiteboard.

15. The machine of claim 8 wherein the machine and coupled peers are additionally coupled to a server that stores metadata of edits corresponding to the machine and corresponding to the coupled peers.

16. A computer-readable program in a computer-readable medium comprising:
a whiteboard application configured to create and update peer layers overlapping a whiteboard for a peer and peers coupled to the peer;
wherein the whiteboard application is configured to send or receive metadata of edits made to one or more of the peer layers; and
further wherein the whiteboard application is configured to update one or more peer layers in response to the metadata of edits.

17. The computer-readable program in a computer-readable medium of claim 16 wherein the whiteboard application merges the peer layers overlapping the whiteboard upon request by the peer or the coupled peers.

18. The computer-readable program in a computer-readable medium of claim 16 wherein the whiteboard application periodically or upon request creates save points of any edits made to one or more peer layers overlapping the whiteboard using a metadata history log.

19. The computer-readable program in a computer-readable medium of claim 16 wherein the whiteboard application is further configured to recover metadata of edits corresponding to the peer from any of the coupled peers when the peer recouples to any of the coupled peers after being decoupled.

20. The computer-readable program in a computer-readable medium of claim 16 wherein the whiteboard application is further configured to send metadata of edits corresponding to any of the recoupling peers when any of the coupled peers are recoupling to the peer after being decoupled.
